(19) United States
(12) Patent Application Publication
(10) Pub. No.: US 2014/0065908 A1
(43) Pub. Date: Mar. 6, 2014

(54) FIBER-REINFORCED COMPOSITE MATERIAL

(71) Applicant: AGENCY FOR DEFENSE DEVELOPMENT, (US)

(72) Inventors: Jae-Yeol LEE, Daejeon (KR); Jong-Kyoo PARK, Daejeon (KR); Yun-Chul KIM, Daejeon (KR); Yong-Gu WON, Daejeon (KR); Byung-Chang KIM, Miryang-si (KR)

(73) Assignee: AGENCY FOR DEFENSE DEVELOPMENT, Daejeon (KR)

(21) Appl. No.: 13/803,802

(22) Filed: Mar. 14, 2013

(30) Foreign Application Priority Data
Sep. 3, 2012 (KR) 10-2012-0097145

(51) Int. Cl. B32B 5/28; C08K 3/04

(52) U.S. Cl. CPC B32B 5/28; C08K 3/04
USPC 442/136; 524/611

(57) ABSTRACT

A fiber-reinforced composite material which comprises Lyocell-based carbon fiber and polymer resin is provided. The fiber-reinforced composite material has excellent physical properties, including low thermal conductivity, excellent interfacial adhesion and excellent strength, compared to fiber-based composite materials prepared using conventional polyacrylonitrile-based carbon fiber, pitch-based carbon fiber or the like. In addition, the fiber-reinforced composite material is environmentally friendly and has low production costs compared to fiber-reinforced composite materials comprising conventional rayon-based carbon fiber produced using a highly toxic carbon disulfide solvent.

### CROSS-REFERENCE TO RELATED APPLICATION

This application claims priority to Korean Patent Application No. KR10-2012-0097145, filed on Sep. 3, 2012, which is incorporated herein by reference in its entirety.

### BACKGROUND OF THE INVENTION

1. Field of the Invention

Exemplary embodiments of the present invention relate to a fiber-reinforced composite material comprising Lyocell-based carbon fiber.

2. Description of Related Art

Fiber-reinforced composite materials comprise polymer resin matrix and reinforcement fiber and have the advantages of lightweight and excellent physical properties.

Generally, as the matrix, natural resin or a synthetic polymer is used, and as the reinforcement fiber, organic fiber such as amide fiber or aramid fiber, or inorganic fiber such as glass fiber or carbon fiber is used.

Among these fibers, the carbon fibers are mainly produced by carbonizing polyacrylonitrile fibers at high temperature, and in some cases, are produced from rayon fibers or pitch fibers.

Fiber-reinforced composite materials comprising conventional carbon fiber have excellent heat resistance and fire resistance etc., and thus can be widely used in various fields, whereas conventional polyacrylonitrile-based carbon fibers have high thermal conductivity, and conventional rayon-based carbon fibers are produced using a highly toxic carbon disulfide solvent which can cause environmental pollution.

### PRIOR ART DOCUMENTS

### Patent Documents

(Patent Document 1) Korean Patent Registration No. 10-1138291

### SUMMARY OF THE INVENTION

An embodiment of the present invention is to provide a fiber-reinforced composite material comprising Lyocell-based carbon fiber, which has low thermal conductivity, excellent interfacial adhesion and low production costs and is environmentally friendly, compared to fiber-reinforced composite materials prepared using conventional carbon fibers.

In accordance with an embodiment of the present invention, a fiber-reinforced composite material includes Lyocell-based carbon fiber and polymer resin.

### DESCRIPTION OF SPECIFIC EMBODIMENTS

Exemplary embodiments of the present invention will be described below.

The present invention provides a fiber-reinforced composite material comprising Lyocell-based carbon fiber and polymer resin.

The Lyocell-based carbon fiber is preferably surrounded by the polymer resin. Specifically, the Lyocell-based carbon fiber serves as reinforcement for the fiber-reinforced composite material, and the polymer resin serves as a matrix that surrounds the Lyocell-based carbon fiber, thereby improving the physical properties of the fiber-reinforced composite material.

The Lyocell-based carbon fiber preferably comprises carbonized Lyocell fiber. Specifically, the Lyocell-based carbon fiber is preferably produced by carbon fiber production processes including a pretreatment process, a stabilization process, a carbonization process and a graphitization process. Lyocell fibers are produced by newly developed processes which do not use a component, which causes environment pollution and is harmful to the human body. These fibers are dry or wet spun fibers produced using cellulose-based natural pulp and the solvent N-methylmorpholine-N-oxide (NMMO), which dissolves pulp, as main materials. The raw material for producing the Lyocell fibers is cellulose extracted from wood pulp, is a completely biodegradable polymer and is recyclable and environmentally friendly. In addition, these fibers can be produced using a process which does not discharge pollutants, unlike conventional rayon fibers.

The Lyocell-based carbon fiber is preferably produced by heat-treating Lyocell fiber at a temperature ranging from 100 to 2800° C. Specifically, the stabilization process is carried out in two steps. Preferably, the first step of the stabilization process is carried out at a temperature ranging from 100 to 250° C. for 10-30 hours, and the second step is carried out at a temperature ranging from 300 to 500° C. for 10-100 hours. If the stabilization process is carried out in the above-described temperature range, the resulting fiber is highly stable without thermal decomposition.

The carbonization process is preferably carried out by heat treatment at a temperature ranging, from 900 to 1700° C. for 10-30 hours. If the carbonization process is carried out in the above temperature range, high carbonization efficiency is ensured.

The graphitization process is preferably carried out by heating the fiber to a graphitization temperature between 2000 and 2800° C. and maintaining the fiber at a temperature between 2000 and 2800° C. for 10 hours or shorter. If the graphitization process is carried in the above temperature range, the degree of graphitization of the fiber can be increased.

The Lyocell-based carbon fiber preferably has a carbon content of 50% or more, and more preferably 80% or more. If the carbon content is within the above range, the carbon fiber-reinforced composite material is lightweight and has excellent strength.

The Lyocell-based carbon fiber preferably has either a long fiber structure consisting of filament yarns or a spun yarn structure made by twisting short fibers, but is not limited thereto.

The Lyocell-based fiber preferably has the form of woven fabric, nonwoven fabric, knitted fabric, multiaxial warp knitted fabric, unidirectional fabric, web or chopped fiber, but is not limited thereto.

The polymer resin is preferably natural polymer resin or synthetic polymer resin. In addition, the polymer resin is preferably thermoplastic resin or thermosetting resin, and more preferably thermoplastic resin. Thermoplastic resin has excellent physical properties such as high strength or hardness, as well as excellent thermal resistance and chemical resistance, and thus maintains its physical properties even upon long-term use. Accordingly, the fiber-reinforced composite material comprising thermoplastic resin can be advantageously used in military and industrial applications requiring high physical properties.

In addition, the polymer resin is preferably phenolic resin, epoxy resin or polyester resin, but is not limited thereto.

The use of phenolic resin, epoxy resin or polyester resin as the polymer resin makes it easy to prepare the fiber-reinforced composite material and is advantageous in economic terms.

In a process of preparing the fiber-reinforced composite of the present invention, before the Lyocell-based carbon fiber is combined with the polymer resin, the Lyocell-based carbon fiber is preferably washed with water or an organic solvent to remove impurities from the surface, and then surface-treated with a salt, oil or a polymer material so that it is easily combined with the polymer resin.

Hereinafter, the present invention will be described with reference to examples, but the scope of the present invention is not limited to these examples.

### EXAMPLE 1

Lyocell fiber was woven into twill fabric using a rapier loom and then washed by immersion in 99.8% pure acetone for about 2 hours. The washed fabric was immersed in a solution of 5 wt % of RTV silicone (silicone-based polymer) in perchloroethylene at about 25° C. for about 30 minutes, and then immersed in an aqueous solution of 15 wt % of ammonium chloride (flame-retardant salt) for about 30 minutes, followed by drying at a temperature of about 80° C.

The pretreated Lyocell fabric was heated in a heat-treatment furnace to a temperature of about 200° C. at a rate of 30° C./hr, and then heated to 300° C. at a rate of 2° C./hr, thereby stabilizing the fabric. Then, the stabilized fabric was heated to 1700° C. at a rate of 50° C./hr and carbonized for 10 hours. The carbonized fabric was heated to 2000° C. at a rate of 100° C./hr and graphitized for 1 hour, thereby manufacturing Lyocell-based carbon fiber fabric which has a carbon content of 90% or more and an areal density of 350 g/m² and consists of long fiber.

A 70% solution of phenolic resin in a methanol solvent was prepared. The Lyocell-based carbon fiber fabric was washed with water to remove impurities from the surface and was surface-treated with a silicone polymer, after which the Lyocell-based carbon fiber fabric was immersed in the phenolic resin solution. The Lyocell-based carbon fiber fabrics immersed in the phenolic resin solution were stacked on top of each other, heated to 150° C. in a hot press, and pressed at 1000 psi for 3 hours, thereby preparing a flat-type fiber-reinforced composite material.

### Comparative Example 1

A fiber-reinforced composite material was prepared in the same manner as Example 1, except that polyacrylonitrile-based carbon fiber was used instead of the Lyocell-based carbon fiber.

### Comparative Example 2

A fiber-reinforced composite material was prepared in the same manner as Example 1, except that non-carbonized Lyocell fiber was used instead of the Lyocell-based carbon fiber.

### Test Example 1

The physical properties of the fiber-reinforced composite materials prepared in Example 1 and Comparative Example 1 were tested, and the results of the test are shown in Table 1 below.

TABLE 1

| | | Comparative |
|---|---|---|
| | Example 1 | Example 1 |
| Thermal conductivity | 1.9 | 2.8 |
| (W/mK) | | |
| Shear strength (MPa) | 17 | 12 |

As can be seen in Table 1 above, the fiber-reinforced composite material prepared in Example 1 according to the present invention showed low thermal conductivity and high shear strength compared to the fiber-reinforced composite material prepared using conventional polyacrylonitrile-based carbon fiber in Comparative Example 1. Thus, the fiber-reinforced composite material of Example 1 has excellent physical properties.

### Test Example 2

The physical properties of the fiber-reinforced composite materials prepared in Example 1 and Comparative Example 2 were tested, and the results of the test are shown in Table 2 below.

TABLE 2

| | | Comparative |
|---|---|---|
| | Example 1 | Example 2 |
| Heat resistance (° C.) | 590 | 270 |

As can be seen in Table 2 above, the fiber-reinforced composite material prepared in Example 1 according to the present invention showed high heat resistance compared to the fiber-reinforced composite material prepared using non-carbonized Lyocell fiber in Comparative Example 2. Thus, the fiber-reinforced composite material of Example 1 has excellent physical properties.

As described above, the fiber-reinforced composite material comprising Lyocell-based carbon fiber according to the present invention has excellent physical properties, including low thermal conductivity, excellent interfacial adhesion and excellent strength, compared to fiber-based composite materials prepared using conventional polyacrylonitrile-based carbon fiber, pitch-based carbon fiber or the like.

In addition, the fiber-reinforced composite material of the present invention comprises Lyocell fiber produced using an N-methylmorpholine-N-oxide (NMMO) solvent, which is harmless to the human body and the environment and is recyclable. Thus, the fiber-reinforced composite material of the present invention is environmentally friendly and has low production costs compared to fiber-reinforced composite materials comprising conventional rayon-based carbon fiber produced using a highly toxic carbon disulfide solvent.

What is claimed is:

1. A fiber-reinforced composite material comprising Lyocell-based carbon fiber and polymer resin.

2. The fiber-reinforced composite material of claim 1, wherein the Lyocell-based carbon fiber comprises carbonized Lyocell fiber.

3. The fiber-reinforced composite material of claim 1, wherein the Lyocell-based carbon fiber is surrounded by the polymer resin.

4. The fiber-reinforced composite material of claim 1, wherein the Lyocell-based carbon fiber is produced by heat-treating Lyocell fiber at a temperature ranging from 100 to 2800° C.

5. The fiber-reinforced composite material of claim 1, wherein the Lyocell-based carbon fiber has either a long fiber structure consisting of filament yarns or a spun yarn structure made by twisting short fibers.

6. The fiber-reinforced composite material of claim 1, wherein the Lyocell-based carbon fiber has a form of woven fabric, nonwoven fabric, knitted fabric, multiaxial warp knitted fabric, unidirectional fabric, web or chopped fiber.

7. The fiber-reinforced composite material of claim 1, wherein the polymer resin is natural polymer resin or synthetic polymer resin.

8. The fiber-reinforced composite material of claim 1, wherein the polymer resin is thermoplastic resin or thermosetting resin.

9. The fiber-reinforced composite material of claim 1, wherein the polymer resin is phenolic resin, epoxy resin or polyester resin.

10. the fiber-reinforced composite material of claim 1, wherein the fiber-reinforced composite material is prepared by washing the Lyocell-based carbon fiber with water or an organic solvent, surface-treating the washed fiber with a salt, oil or a polymer material, and combining the surface-treated fiber with the polymer resin.
